(19) United States
(12) Patent Application Publication
(10) Pub. No.: US 2007/0189260 A1
(43) Pub. Date: Aug. 16, 2007

(54) METHOD AND APPARATUS FOR DETECTING CHANNEL TYPES AND METHOD OF EMPLOYING SAME

(75) Inventor: Chia-Yi Chang, I-Lan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/458,119

(22) Filed: Jul. 18, 2006

Related U.S. Application Data
(60) Provisional application No. 60/773,112, filed on Feb. 14, 2006.

(51) Int. Cl. H04B 7/216

(52) U.S. Cl. 370/342

(57) ABSTRACT

A method for detecting channel types of a channel. The method includes begins with receiving a data stream from the channel. The data stream comprises a plurality of data sections, and each data section includes a training sequence and at least one data sequence. A training-sequence noise is formed according to training-sequence noise information of the training sequence. A data-sequence noise is also formed by calculating data-sequence noise information of the data sequences. A D/T ratio is then formed by dividing the data-sequence noise with the training-sequence noise. The channel type is determined according to the D/T ratio.

This application claims the benefit of U.S. Provisional Application No. 60/773,112, filed Feb. 14, 2006, and entitled “HIGH SPEED CHANNEL DETECTION BY USING REBUILD NOSE VARIATION”.

### BACKGROUND OF THE INVENTION

### Field of the Invention

The invention relates to channel detection, and more particularly, to detecting timing-variation of channels.

Communication systems, such as time-division multiple access (TDMA), frequency-division multiple access (FDMA), or code-division multiple access (CDMA), allow a large number of users to send information through a communication channel to the corresponding receivers. For example, in GSM communication system, a plurality of base stations are set to forward signals to and from mobiles in one communication area. Each base station utilities one frequency band to transmit signals, where the frequency band must be different to those of its adjacent base stations. Currently, to support more users and more signal forwarding, the communication system however needs to allocate more base stations in one communication area. It then makes the base stations utilizing the same frequency band become closer to each other and results in so-called co-channel interference problem.

To reduce the co-channel interference problem, the received signals at mobiles are further speech encoded and channel encoded. Here, speech encoding is to compress the received signals with different encoding rates. For example, the GSM system is encoded by 13 Kbps RPE (Regular-Pulse Excitation) speech encoder. If current communication channel is seriously interfered, the received signals will be encoded by less encoding rates. As to the channel encoding, such as forward error correction (FEC) or automatic repeat request (ARQ) technique, it expands the received signals into longer code words so as to reduce the interfered bit ratio.

Generally, the communication system adopts constant speech encoding rate and constant channel encoding rate for one data transmission. However, the communication channel quality may vary during the data transmission. Therefore, a new encoding technique is provided. In this new system, the speech encoding rate and the channel encoding rate can be dynamically adjusted based on current communication quality. For example, if the current communication quality gets worse, the system will lower the speech encoding rate to produce better speech signals and increase the channel encoding rate to reduce the interfered bit ratio. On the other hand, if the communication quality gets better, the system may lower the channel encoding rate to speed up data transmission.

In GSM system, the communication quality can be a carrier-to-inference (C/I) ratio of the received signals. FIG. 1 illustrates a block diagram for transmission quality estimation based on carrier and interference source energy estimation. Streaming data is processed by a correlator and channel estimator block 10. The channel estimate result is used by the carrier energy (C) estimation block 12 and the interference energy (I) estimation block 14. The outputs of the (C) estimation block 12 and the (I) estimation block 14 are then fed to block 16. Block 16 computes the ratio of these two energies to generate a carrier-to-interference energy (C/I) estimate result. This C/I estimate result is further linearized and filtered by block 18 to compute the final channel quality estimate (CQE).

FIG. 2 shows a block diagram for transmission quality estimation based on raw bit error rate. Channel decoder 22 decodes demodulator output. A channel re-encoder 24 encodes the decoded data. A comparator 26 compares error bits of the demodulated output and the re-encoded data. The ratio of error bits and total bit number is the raw bit error rate filtered through a smoothing filter 28 to eliminate instantaneous fluctuations. The smoothed raw bit error rate is then mapped to C/I ratio in dB by a mapping polynomial 29.

However, the C/I ratio estimated in either FIG. 1 or FIG. 2 provides unsatisfactory results when transmitting through fading channels. Fading channels, commonly encountered in mobile communication systems, have random time variant impulse responses, which are more difficult to analyze than classical AWGN channels. For significantly faded channels, the variance of the C/I estimates is so high that the C/I estimation may lead to misinterpretation of actual channel conditions, and the overall performance of channel utilization would degrade.

### BRIEF SUMMARY OF THE INVENTION

Accordingly, the invention provides method and apparatus for dynamically detecting channel types. In one aspect of the invention, the proposed apparatus comprises a training-sequence noise, a data-sequence noise estimator, and a channel detector. The apparatus detects timing variation of a channel from a received data stream, wherein the data stream comprises a plurality of data sequences and a training sequence. The training-sequence noise estimator forms training-sequence noise E_{noise,Tsc} according to training-sequence noise information. The data-sequence noise estimator calculates data-sequence noise information of the data sequences to form a data-sequence noise E_{noise,data}. The channel detector divides the data-sequence noise by the training-sequence noise to form a D/T ratio, determines that the timing variation of the channel is high when the D/T ratio exceeds a threshold, and determines that the timing variation of the channel is medium or low when the D/T ratio is less than the threshold.

In another aspect of the invention, a method for detecting a channel type is provided. The method comprises begins with receiving a data stream from the channel. The data stream comprises a plurality of data sections, and each data section comprises a training sequence and at least one data sequence. A training-sequence noise is formed according to training-sequence noise information of the training sequence. A data-sequence noise is also formed by calculating data-sequence noise information of the data sequences. A D/T ratio is then formed by dividing the data-sequence noise with the training-sequence noise. The channel type is determined according to the D/T ratio.

Channel utilization can be improved by employing the channel type accurately detected in the above method/apparatus. For example, a user on a static fading channel may request high quality data or voice transmission, and another user on a fast fading channel may be served with poorer data/voice quality but at least accurate data/voice. The user on a static fading channel would need better data/voice compression techniques, and the user on a fast fading channel would need robust error correction. The well estimated channel type in the described method/apparatus aids transmitters in the communication systems to decide which combination of compression technique and error correction should be employed. Therefore, in one aspect of the invention, a method for selecting source-and-channel encoding schemes is provided. The method begins with receiving a data stream from a channel, where the data stream comprises a plurality of data sections, and each data section comprises a training sequence and at least one data sequence. A training-sequence noise, a data-sequence noise, and a D/T ratio are formed the same as in the previously described method. A first encoding scheme is selected when the D/T ratio exceeds a threshold, and a second encoding scheme is selected when the D/T ratio is less than the threshold. The first encoding scheme has a lower compression rate and/or a higher channel encoding rate than the second encoding scheme.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 illustrates a block diagram for transmission quality estimation based on carrier and interferer energy estimation;

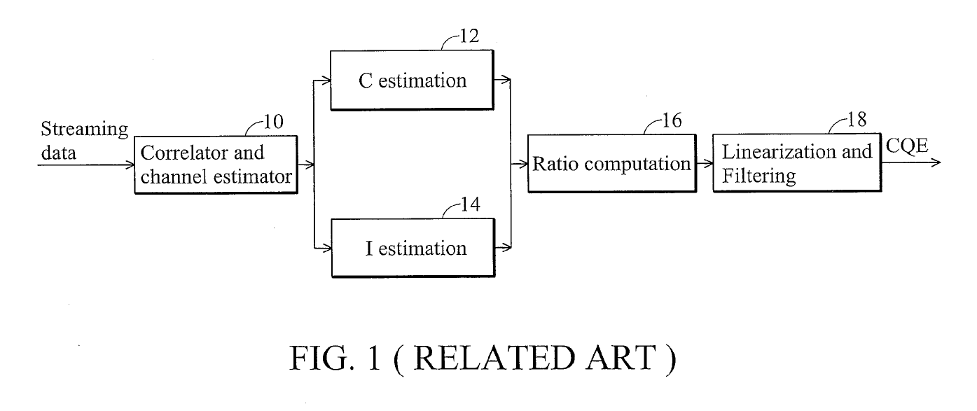

FIG. 2 shows a block diagram for transmission quality estimation based on raw bit error rate;

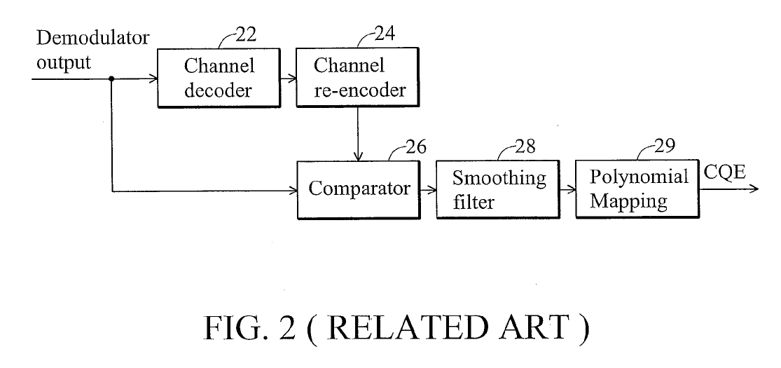

FIG. 3 shows an exemplary block diagram of an apparatus for detecting timing variation of a channel according to an embodiment of the invention;

FIG. 4 shows an exemplary block diagram of the training sequence noise estimator 302;

FIG. 5 shows an exemplary structure of the data stream comprising a first data sequence, a training sequence and a second data sequence;

FIG. 6 shows an exemplary plot of the C/I and the D/T ratio;

FIG. 7 shows a flowchart of detecting channel types of a channel according to an embodiment of the invention;

FIG. 8 shows a flowchart of forming the training-sequence noise E_{noise,TSC} according an embodiment of the invention; and

FIG. 9 shows a flowchart of selecting encoding schemes of a channel according to an embodiment of the invention.

### DETAILED DESCRIPTION OF THE INVENTION

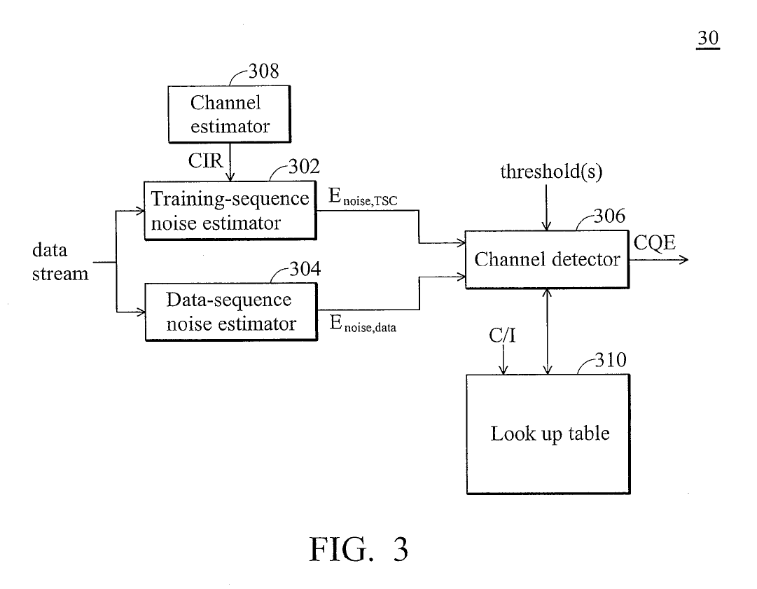

FIG. 3 shows an exemplary block diagram of an apparatus 30 for detecting timing variation of a channel according to an embodiment of the invention. The apparatus detects timing variation of the channel from a data stream which is received from the channel, wherein the data stream comprises at least one data sequence(s) and a training sequence. The apparatus 30 comprises a training-sequence noise estimator 302, a data-sequence noise estimator 304, and a channel detector 306. The training-sequence noise estimator 302 forms a training-sequence noise E_{noise,TSC} according to the training sequence noise information which is inherent in the received data stream. The data-sequence noise estimator 304 forms a data-sequence noise E_{noise,data} according to the data sequence(s) of the received data stream. The channel detector 306 divides the data-sequence noise E_{noise,data} by the training-sequence noise E_{noise,TSC} to form a D/T ratio, determines that the amount of the timing variation and outputs a channel quality estimate (CQE). In some embodiments, the D/T ratio can be expressed in decibels, which is as shown by the following formula:

$$10 \cdot {log}_{10} ( \frac{{E}_{noise , data}}{{E}_{noise , TSC}} ) . \qquad ( 1 )$$

When the D/T ratio exceeds a threshold, the timing variation of the channel is recognized as high. When the D/T ratio is less than the threshold, the timing variation of the channel is recognized as medium or low.

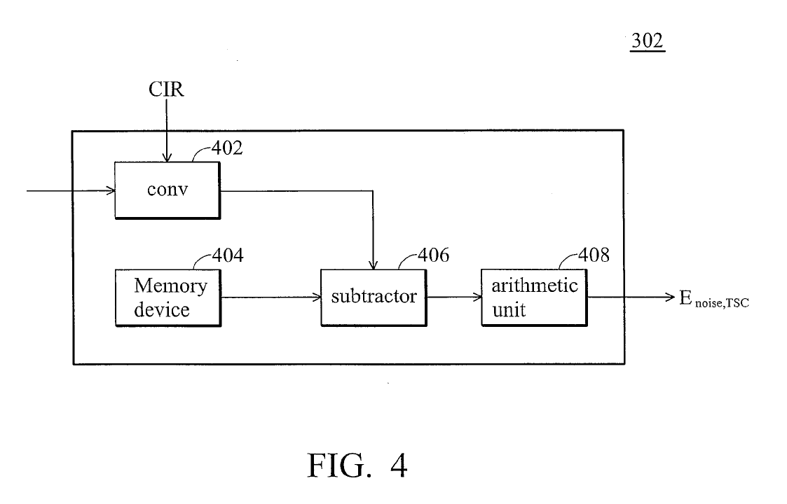

In some embodiment of the invention, to estimate the training sequence noise information in the training sequence, the apparatus 30 comprises a channel estimator 308 estimating the channel impulse response (CIR) of the channel. Since the training sequence is the pattern both known by the transmission end and the receiving end, a rebuilt training sequence can be formed by convoluting the channel impulse response (CIR) with a training sequence previously stored in the training-sequence noise estimator 302. The training-sequence noise information is C formed by subtracting the previously stored training sequence with the rebuilt training sequence. In preferred embodiments of the invention, the training-sequence noise E_{noise,Tsc} is formed according to the following formula:

$${E}_{noise , TSC} = \frac{1}{N} {\sum }_{i = 0}^{N - 1} {\vert r ( i ) - {r}_{rebuilt} ( i ) \vert}^{2} , \qquad ( 2 )$$

wherein r(i) is the i^{th} bit of the training sequence, r_{rebuilt}(i) is the i^{th} bit of the rebuilt training sequence, and N is the number of bits of the training sequence. FIG. 4 shows an exemplary block diagram of the training sequence noise estimator 302. A convolution block (conv) 402 convolutes the CIR with the received training sequence to obtain a rebuilt training sequence. A memory device 404 stores the ideal training sequence. A subtractor 406 subtracts the rebuilt training sequence with the previously stored training sequence. An arithmetic unit 408 does the calculation of E_{noise,Tsc} as defined in equation (2).

In some embodiments of the invention, the data-sequence noise estimator 304 is a viterbi equalizer forming the data-sequence noise E_{noise,data} according to the following formula:

$${E}_{noise , data} = \frac{1}{L} ( NM ) , \qquad ( 3 )$$

wherein NM is the node metric of the data sequence, representing the bits of the data sequence which differ from a candidate sequence, and L is the number of bits in the data sequence. The NM used herein can be the Hamming distance for hard decision or Euclidean distance for soft decision. Additionally, other equivalent metrics can also be used without deviating from the spirit and scope of the invention. The NM, defined by equation (2) is referred to as the relative error weight metric. It gives a measure of the difference between the accumulated metrics of paths taken by a convolutional encoder and a viterbi equalizer 304 through a trellis, normalized by the overall magnitude of the soft bits. On one hand, a lower magnitude NM implies that the path taken by the viterbi equalizer 304 deviated only for a few branches from the original path taken by the convolutional encoder through the trellis, and hence indicates better channel quality. On the other hand, higher magnitude NM implies that the path taken by the viterbi equalizer 304 deviated from the correct path in several branches, thus indicating poor channel quality.

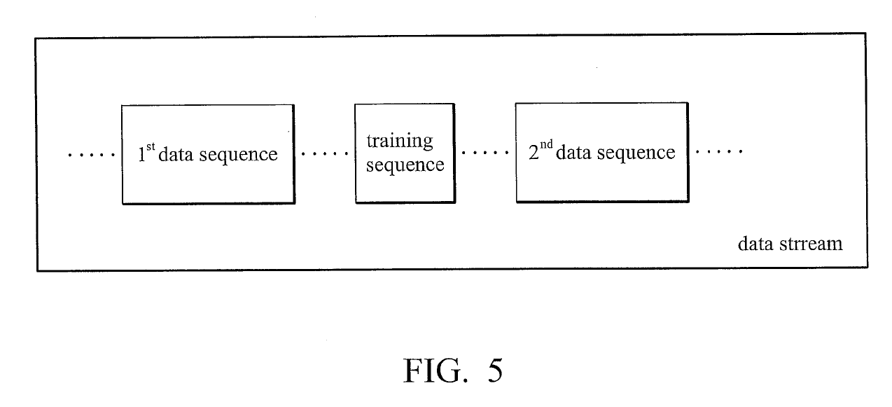

The calculation of NM may vary with the structure of the received data stream. For example, as shown in FIG. 5, the structure of the data stream may be a first data sequence, followed by the training sequence and a second data sequence. The data-sequence noise E_{noise,data} is formed according to:

$${E}_{noise , data} = \frac{1}{L} ( {NM}_{1} + {NM}_{2} ) , \qquad ( 4 )$$

wherein NM₁ is a first node metric of the first data sequence, NM₂ is a second node metric of the second data sequence, and L is total bits of the first and second data sequences.

In some embodiments of the invention, the channel detector 306 can distinguish multi-level timing variation. For example, the channel detector 306 determines the timing variation of the channel is a high when the D/T ratio exceeds a first threshold T₁, determines the timing variation of the channel is a 2^{nd} fast channel is when the D/T ratio is less than the first threshold but exceeds a second threshold T₂, and the determines the timing variation of the channel is a n^{th} fast channel when the D/T ratio is less than a (n−1)^{th} Tₙ₋₁ threshold but exceeds n^{th} threshold Tₙ, wherein T₁>T₂> . . . Tₙ₋₁>Tₙ.

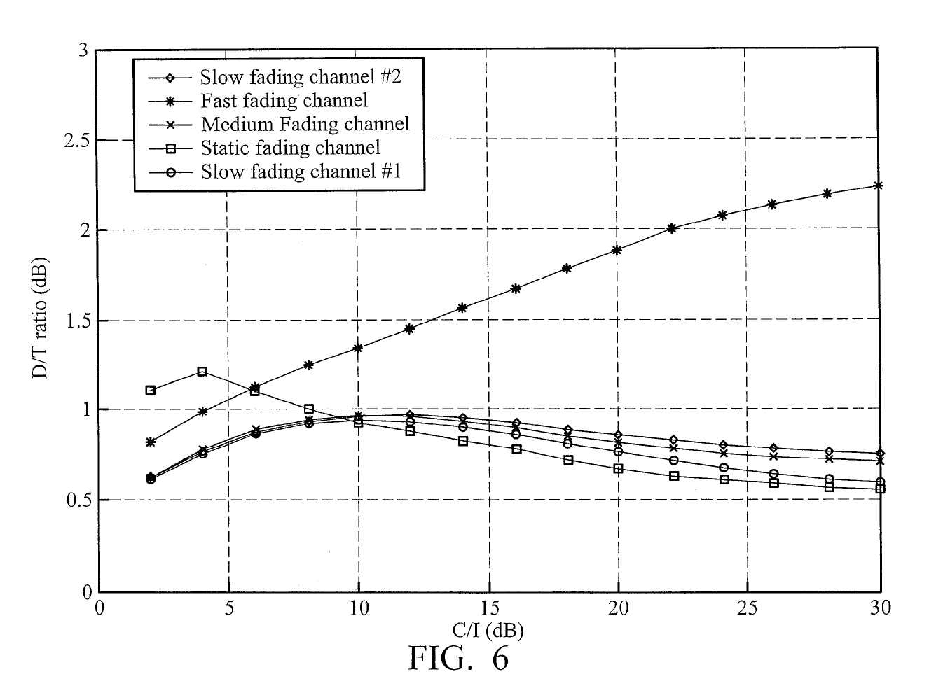

In a preferred embodiment of the invention, the channel detector 306 determines the timing variation of a channel according to both the D/T ratio a given carrier-interference ratio (C/I). For example, FIG. 6 shows an exemplary plot of the C/I and the D/T ratio. For a fast fading channel, the D/T ratio grows high as C/I increases. Suppose a roughly estimated C/I is about 15 dB, and a resulting D/T exceeds a threshold 1.2 dB, the channel detector 306 recognizes the timing variation of a channel is high. On the other hand, if a D/T is less than 1.2 dB when C/I is about 15 dB, the channel detector 306 recognizes the timing variation of the channel is low or medium. The thresholds under different C/I may store in a look-up table 310.

The D/T ratio indicates the timing-variation of the channel impulse response estimated by the channel estimator 308. The channel estimator 308 estimates channel impulse response only when a training sequence is received. For a fast timing-variant channel, the exact channel impulse response may change so rapidly that the channel impulse response estimated when receiving a training sequence is not applicable when receiving a data sequence. Thus, in some cases, a larger D/T ratio indicates a worse estimation error of the estimated channel impulse response, which results from a violent timing-variant channel.

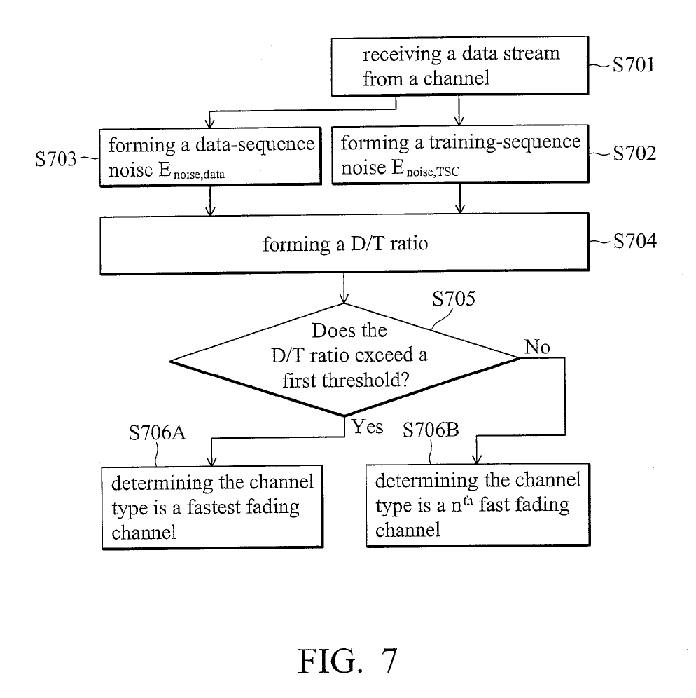

FIG. 7 shows a flowchart of detecting the channel type of a channel according to an embodiment of the invention. A data stream is received from the channel in step S701, wherein the data stream comprises a plurality of data sections, and each data section comprises a training sequence and at least one data sequences. A training-sequence noise E_{noise,TSC} is formed in step S702 according to training sequence noise information. A data-sequence noise E_{noise,data} is formed in step S703 according to data-sequence noise information of the data sequence(s). A D/T ratio is formed in step S704 by dividing the data-sequence noise E_{noise,data} with the training-sequence noise E_{noise,TSC}. The D/T ratio is compared with a threshold in step Sx05. If the D/T ratio exceeds a threshold, the channel type is determined as a fast-fading channel in step S706A. If the D/T ratio is less than the threshold, the channel type is determined as a slow- or medium-fading channel in step S706B.

In some embodiments of the invention, the D/T ratio is compared with the first threshold T₁, a second threshold T₂, . . . , a (n−1)^{th} threshold Tₙ₋₁, and a n^{th} threshold Tₙ in step S705. If the D/T ratio exceeds the first threshold T₁, the channel type is determined as a fast-fading channel in step S706A. If the D/T ratio exceeds the (n−1)^{th} threshold Tₙ₋₁ but exceeds n^{th} threshold Tₙ, the channel type is determined as a n^{th} fast-fading channel in step S706B when the D/T ratio is less than a (n−1)^{th} threshold Tₙ₋₁ but exceeds nₜₕ threshold Tₙ, wherein T₁>T₂> . . . Tₙ₋₁>Tₙ. However, the step S706B is optional and it may be modified based on different designs.

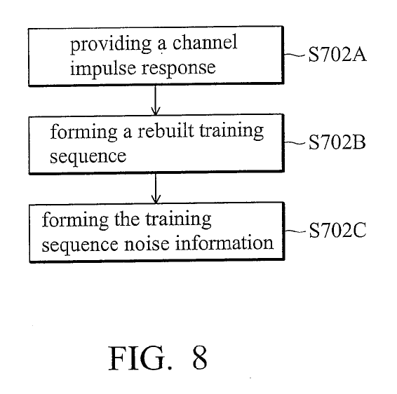

FIG. 8 shows the steps of flowchart of forming the training-sequence noise E_{noise,TSC} according an embodiment of the invention. A channel impulse response is provided in step S702A. A rebuilt training sequence is formed in step S702B by convoluting the channel impulse response with a previously stored training sequence, wherein the previously stored training sequence is a transmitted training sequence corresponding to the received training sequence. The training-sequence noise information is formed in step S702C by subtracting the previously stored training sequence with the rebuilt training sequence. In preferred embodiments of the invention, the training-sequence noise E_{noise,TSC} is formed according to equation (2).

In one embodiment of the invention, the node metric of the data sequence(s) in step S703 is formed by a Viterbi equalizer. The data sequence noise E_{noise,data} in step S702 is formed according to equation (3). The calculation of NM may vary with the structure of the received data stream. For example, the structure of the data stream may be a first data sequence, followed by the training sequence and a second data sequence. In this way, the data sequence noise E_{noise,data} is according formed to equation (4).

In some embodiments, the D/T ratio formed in step S704 can be expressed in decibels as shown in equation (1).

In a preferred embodiment of the invention, the channel type is determined according to not only the D/T ratio, but also a carrier-interference ratio (C/I). As shown in FIG. 6, the D/T ratio is dependent to C/I. In other words, the threshold value may vary with C/I. Suppose a roughly estimated C/I is about 15 dB, and a resulting D/T exceeds a threshold 1.2 dB, the channel type is determined as fast fading. On the other hand, if the D/T is less than 1.2 dB when C/I is about 15 dB, the channel type is determined as slow or medium fading. When the C/I is low, the index D/T may provide less information about timing variation.

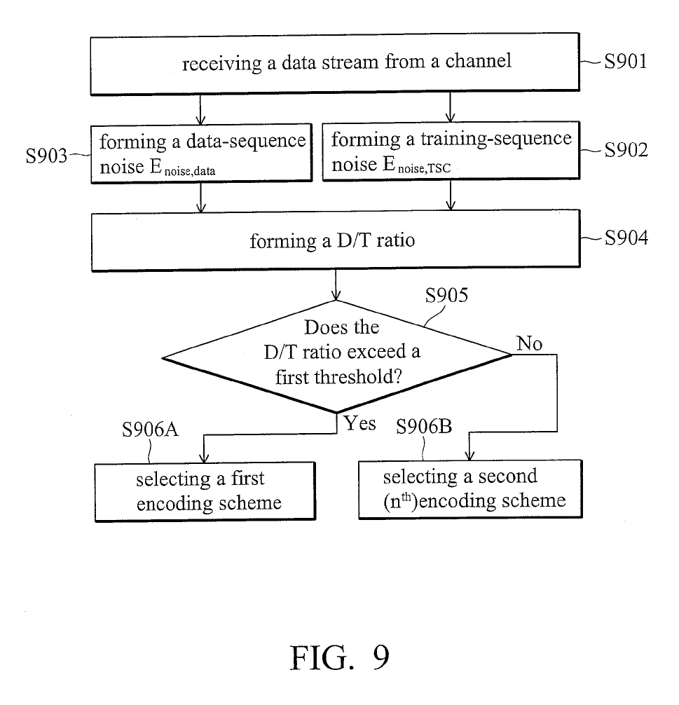

The D/T ratio can be a useful index of channel quality estimation. In some popular telecommunication services, such as GSM, the transmission rate to/from a user is determined by the channel quality. For example, for voice and/or data services, a user on a static fading channel may receive higher voice quality and/or data throughput and a user on a fast fading channel may receive lower voice quality but with a reliable accuracy. Therefore, the D/T ratio can be used to decide which source coding and channel encoding scheme should be employed. FIG. 9 shows a flowchart of selecting encoding schemes of a channel according to an embodiment of the invention. A data stream is received from the channel in step S901, wherein the data stream comprises a plurality of data sections, and each data section comprises a training sequence and at least one data sequence(s). A training-sequence noise E_{noise,Tsc} is formed in step S902 according to training sequence noise information. A data-sequence noise E_{noise,data} is formed in step S903 according to data-sequence noise information of the data sequence(s). A D/T ratio is formed in step S904 by dividing the data-sequence noise E_{noise,data} with the training-sequence noise E_{noise,TSC}. The D/T ratio is compared with a threshold in step S905. If the D/T ratio exceeds a threshold, a first encoding scheme is selected in step S906A. If the D/T ratio is less than the threshold, a second encoding scheme is selected in step S906B, wherein a second code rate of the second encoding scheme exceeds a first code rate of the first encoding scheme.

In some embodiments of the invention, the D/T ratio is compared with the first threshold T₁, a second threshold T₂, . . . , a (n−1)^{th} threshold Tₙ₋₁, and a nₜₕ threshold Tₙ in step S905. If the D/T ratio exceeds the first threshold T₁, the first encoding scheme having the first source coding rate S₁ and the first channel coding rate C₁ is selected in step S906A. If the D/T ratio exceeds the (n−1)^{th} threshold Tₙ₋₁ and is less than the n^{th} threshold Tₙ, a n^{th} encoding scheme having a nₜₕ source coding rate Sₙ and a n^{th} channel coding rate Cₙ is selected in step S906B, wherein T₁> . . . Tₙ₋₁, >Tₙ, S₁>S₂> . . . >Sₙ₋₁>Sₙ, and C₁≧C₂≧ . . . ≧Cₙ₋₁≧Cₙ.

The steps of forming the training-sequence noise E_{noise,TSC} are similar to those shown in FIG. 8. A channel impulse response is provided in step S702A. A rebuilt training sequence is formed in step S702B by convoluting the channel impulse response with a previously stored training sequence, wherein the previously stored training sequence is a transmitted training sequence corresponding to the received training sequence. The training-sequence noise information is formed in step S702C by subtracting the previously stored training sequence with the rebuilt training sequence. In preferred embodiments of the invention, the training-sequence noise E_{noise,TSC} is formed according to equation (2).

The node metric of the data sequence(s) in step S903 is formed by a Viterbi equalizer. In some embodiments, the data sequence noise E_{noise,data} in step S903 may be formed according to equation (3). The calculation of NM may vary with the structure of the received data stream. For example, the structure of the data stream may be a first data sequence, followed by the training sequence and a second data sequence. Thus, the data sequence noise E_{noise,data} formed in step S903 is formed according to equation (4).

In some embodiments, the D/T ratio formed in step S904 can be expressed in decibels as shown in equation (1).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for detecting timing variation of a channel from a received data stream, wherein the data stream comprises a plurality of data sequences and a training sequence, and the apparatus comprises:
a training-sequence noise estimator forming a training-sequence noise according to training-sequence noise information;
a data-sequence noise estimator calculating data-sequence noise information of the data sequences to form a data-sequence noise; and
a channel detector dividing the data-sequence noise by the training-sequence noise to form a D/T ratio, determining that the timing variation of the channel is high when the D/T ratio exceeds a threshold, and determining that the timing variation of the channel is medium or low when the D/T ratio is less than the threshold.

2. The apparatus as claimed in claim 1 further comprising a channel estimator estimating a channel impulse response, wherein the training-sequence noise estimator further forms a rebuilt training sequence by convoluting the channel impulse response with a training sequence previously stored in the training-sequence noise estimator and forms the training-sequence noise information by subtracting the previously stored training sequence with the rebuilt training sequence.

3. The apparatus as claimed in claim 1, wherein the training-sequence noise estimator performs the following formula to form the training-sequence noise E_{noise,TSC}:
$${E}_{noise , TSC} = \frac{1}{N} {\sum }_{i = 0}^{N - 1} {\vert r ( i ) - {r}_{rebuilt} ( i ) \vert}^{2} ,$$
wherein r(i) is the i^{th} bit of the training sequence, r_{rebuilt}(i) is the i^{th} bit of the rebuilt training sequence, and N is the number of bits of the training sequence.

4. The apparatus as claimed in claim 3, wherein the data-sequence noise estimator is a viterbi equalizer, and the data-sequence noise estimator forms the data-sequence noise E_{noise,data} according to the following formula:
$${E}_{noise , data} = \frac{1}{L} ( NM ) ,$$
wherein NM is the node metric of the data sequence, representing a bit-number of the data sequence differs from a candidate sequence, and L is the bits number of the data sequence.

5. The apparatus as claimed in claim 4, wherein the data stream is a first data sequence, followed by the training sequence and a second data sequence, the data-sequence noise E_{noise,data} is formed according to the following formula:
$${E}_{noise , data} = \frac{1}{L} ( {NM}_{1} + {NM}_{2} ) ,$$
wherein NM₁ is a first node metric of the first data sequence, NM₂ is a second node metric of the second data sequence, and L is the total bits of the first and second data sequences.

6. The apparatus as claimed in claim 5, wherein the channel detector estimator further takes a logarithm of the D/T ratio to form a logarithmic D/T ratio, determines that the timing variation of the channel is fast when the logarithmic D/T ratio exceeds a logarithm threshold, and determines that the timing variation of the channel is medium or slow when the logarithmic D/T ratio is less than the logarithmic threshold.

7. The apparatus as claimed in claim 6, wherein the channel detector estimator further takes a base 10 logarithm of the D/T ratio to form the logarithmic D/T ratio.

8. The apparatus as claimed in claim 1, wherein the threshold is a first threshold, and the channel detector determines the timing variation of the channel is a fastest channel when the D/T ratio exceeds the first threshold T₁, the channel detector determines the timing variation of the channel is a 2^{nd} fast channel when the D/T ratio is less than the first threshold but exceeds a second threshold T₂, and the channel detector determines the timing variation of the channel is a n^{th} fast channel when the D/T ratio is less than a (n−1)^{th} threshold Tₙ₋₁ but exceeds a n^{th} threshold Tₙ, wherein T₁>T₂> . . . Tₙ₋₁>Tₙ.

9. The apparatus as claimed in claim 1, wherein the channel detector further receives a carrier-to-interference (C/I) ratio, and the channel detector checks a table according to the C/I and the D/T ratio to determine the timing variation of the channel.

10. A method for detecting channel types of a channel, comprising:
receiving a data stream from the channel, wherein the data stream comprises a plurality of data sections, and each data section comprises a training sequence and at least one data sequences;
forming a training-sequence noise according to training-sequence noise information of the training sequence;
forming a data-sequence noise by calculating data-sequence noise information of the data sequences;
forming a D/T ratio by dividing the data-sequence noise with the training-sequence noise; and
determining if the channel type is a fast-fading channel according to the D/T ratio.

11. The method as claimed in claim 10, wherein forming the training-sequence noise step further comprises:
providing a channel impulse response;
forming a rebuilt training sequence by convoluting the channel impulse response with a previously stored training sequence, wherein the previously stored training sequence is a transmitted training sequence corresponding to the received training sequence; and
forming the training-sequence noise by subtracting the previously stored training sequence with the rebuilt training sequence.

12. The method as claimed in claim 10, wherein the training-sequence noise E_{noise,TSC} is formed according to the following formula:
$${E}_{noise , TSC} = \frac{1}{N} {\sum }_{i = 0}^{N - 1} {\vert r ( i ) - {r}_{rebuilt} ( i ) \vert}^{2} ,$$
wherein r(i) is the i^{th} bit of the training sequence, r_{rebuilt}(i) is the i^{th} bit of the rebuilt training sequence, and N is the number of bits of the training sequence.

13. The method as claimed in claim 10, wherein forming the data-sequence noise step further comprises:
providing a node metric of the data sequences by a Viterbi equalizer; and
forming the data sequence noise E_{noise,data} according to the following formula:
$${E}_{noise , data} = \frac{1}{L} ( NM ) ,$$
wherein NM is the node metric of the data sequence, representing bits of the data sequence which differ from a candidate sequence, and L is the total bits of the data sequences.

14. The method as claimed in claim 13, wherein the data stream comprises a first data sequence, followed by the training sequence and a second data sequence, the node metric of the data sequences comprises a first node metric of the first data sequence and a second node metric of the second data sequence, and the data-sequence noise E_{noise,data} is formed according to the following formula:
$${E}_{noise , data} = \frac{1}{L} ( {NM}_{1} + {NM}_{2} ) ,$$
wherein NM₁ is the first node metric, NM₂ is the second node metric, and L is the total bits of the first and second data sequences.

15. The method as claimed in claim 10, wherein the step of determining the channel type of the channel comprises:
determining that the channel is the fast-fading channel when the D/T ratio exceeds a threshold; and
determining that the channel is a slow-/medium-fading channel when the D/T ratio is less than the threshold.

16. The method as claimed in claim 10, wherein the D/T ratio is updated by taking a logarithm of the D/T ratio.

17. The method as claimed in claim 16, wherein the D/T ratio is updated by taking a base 10 logarithm of the D/T ratio.

18. The method as claimed in claim 15, wherein the threshold is a first threshold T₁, further comprising:
determining the channel type is a fastest-fading channel when the D/T ratio exceeds the first threshold T₁;
determining the channel type is a 2^{nd} fast-fading channel when the D/T ratio is less than the first threshold T₁ but exceeds a second threshold T₂; and
determining the channel type is a n^{th} fast-fading channel when the D/T ratio is less than a (n−1)^{th} threshold Tₙ₋₁ but exceeds a n^{th} threshold Tₙ, wherein T₁>T₂> . . . Tₙ₋₁>Tₙ.

19. The method as claimed in claim 10 further comprises providing a carrier-to-interference (C/I) ratio, and the channel type is determined according to both the C/I and the D/T ratio.

20. A method for selecting encoding schemes, comprising:
receiving a data stream from a channel, wherein the data stream comprises a plurality of data sections, and each data section comprises a training sequence and at least one data sequences;
forming a training-sequence noise by calculating training-sequence noise information of the training sequence;
forming a data-sequence noise by calculating data-sequence noise information of the data sequences;
forming a D/T ratio by dividing the data-sequence noise with the training-sequence noise; and
selecting a first encoding scheme when the D/T ratio exceeds a threshold, and selecting a second encoding scheme when the D/T ratio is less than the threshold, wherein the first encoding scheme has a first source coding rate and a first channel coding rate, and the second encoding scheme has a second source coding rate and a second channel coding rate, the first source coding rate has a lower compression ratio than the second source coding rate, and the first channel coding rate is equal to or higher than the second channel coding rate.

21. The method as claimed in claim 20, wherein forming the training-sequence noise step further comprises:
providing a channel impulse response;
forming a rebuilt training sequence by convoluting the channel impulse response with a previously stored training sequence, wherein the previously stored training sequence is a transmitted training sequence corresponding to the received training sequence; and
forming the training-sequence noise by subtracting the previous stored training sequence with the rebuilt training sequence.

22. The method as claimed in claim 20, wherein the training-sequence noise E_{noise,TSC} is formed according to the following formula:
$${E}_{noise , TSC} = \frac{1}{N} {\sum }_{i = 0}^{N - 1} {\vert r ( i ) - {r}_{rebuilt} ( i ) \vert}^{2} ,$$
wherein r(i) is the i^{th} bit of the training sequence, r_{rebuilt}(i) is the i^{th} bit of the rebuilt training sequence, N is the total bits of the training sequence.

23. The method as claimed in claim 22, wherein forming the data-sequence noise step further comprises:
providing a node metric of the data sequences by a Viterbi equalizer; and
forming the data sequence noise according to the following formula:
$${E}_{noise , data} = \frac{1}{L} ( NM ) ,$$
wherein NM is the node metric of the data sequence, representing the number of bits in the data sequence which differs from a candidate sequence, and L is the total bits of the data sequences.

24. The method as claimed in claim 23, wherein the data stream comprises a first data sequence, followed by the training sequence and a second data sequence, the node metric of the data sequence comprises a first node metric of the first data sequence and a second node metric of the second data sequence, and the data-sequence noise E_{noise,data} is formed according to the following formula:
$${E}_{noise , data} = \frac{1}{L} ( {NM}_{1} + {NM}_{2} ) ,$$
wherein NM₁ is the first node metric, NM₂ is the second node metric, and L is the total bits of the first and second data sequences.

25. The method as claimed in claim 24 further comprising updating the D/T ratio by a taking logarithm of the D/T ratio.

26. The method as claimed in claim 25, further comprising updating the D/T ratio by taking a base 10 logarithm of the D/T ratio.

27. The method as claimed in claim 20, wherein the threshold is a first threshold T₁, and the method further comprises:
selecting the first encoding scheme having the first source coding rate S₁ and the first channel coding rate C₁ when the D/T ratio exceeds the first threshold T₁;
selecting the second encoding scheme having the second source coding rate S₂ and the second channel coding rate C₂ when the D/T ratio is less than the first threshold T₁ but exceeds a second threshold T₂; and
selecting a n^{th} encoding scheme having a n^{th} source coding rate Sₙ and a n^{th} channel coding rate Cₙ when the D/T ratio is less than a (n−1)^{th} threshold Tₙ₋₁ but exceeds a n^{th} threshold Tₙ, wherein T₁>T₂> . . . Tₙ₋₁>Tₙ, S₁>S₂> . . . >Sₙ₋₁>Sₙ, and C₁>C₂≧ . . . ≧Cₙ₋₁≧Cₙ.

28. An apparatus for detecting timing variation of a channel from a received data stream, wherein the data stream comprises a plurality of data sequences and a training sequence, and the apparatus comprises:
a training-sequence noise estimator forming a training-sequence noise according to training-sequence noise information;
a data-sequence noise estimator calculating data-sequence noise information of the data sequences to form a data-sequence noise; and
a channel detector estimating a D/T ratio based on the data-sequence noise and the training-sequence noise, wherein the channel detector detects the timing variation based on the estimated D/T ratio.

29. An apparatus for selecting encoding schemes, comprising:
a receiver for receiving a data stream from a channel, wherein the data stream comprises a plurality of data sections, and each data section comprises a training sequence and at least one data sequences;
a training sequence noise estimator, coupled to the receiver, for forming a training-sequence noise by calculating training-sequence noise information of the training sequence;
a data sequence noise estimation, coupled to the receiver, for forming a data-sequence noise by calculating data-sequence noise information of the data sequences; and
a channel detector, coupled to the training sequence noise estimator and the data sequence noise estimation, for estimating a D/T ratio based on the data-sequence noise and the training-sequence noise;
wherein the channel detector further compares the D/T ratio with a predetermined threshold, and the channel detector selects a first encoding scheme when the D/T ratio exceeds the threshold, and the channel detector selects a second encoding scheme when the D/T ratio is less than the threshold.

30. The apparatus as claimed in claim 29, wherein the first encoding scheme has a first source coding rate and a first channel coding rate, and the second encoding scheme has a second source coding rate and a second channel coding rate, the first source coding rate has a lower compression ratio than the second source coding rate, and the first channel coding rate is equal to or higher than the second channel coding rate.
